(19) United States
(12) Patent Application Publication
(10) Pub. No.: US 2023/0018896 A1
(43) Pub. Date: Jan. 19, 2023

(54) RECHARGEABLE BATTERY

(71) Applicant: ZEROPLUS TECHNOLOGY CO., LTD., New Taipei City (TW)

(72) Inventor: CHIU-HAO CHENG, New Taipei City (TW)

(73) Assignee: ZEROPLUS TECHNOLOGY CO., LTD., New Taipei City (TW)

(21) Appl. No.: 17/835,683

(22) Filed: Jun. 8, 2022

(30) Foreign Application Priority Data
Jul. 19, 2021 (TW) 110126447
May 26, 2022 (TW) 111119697

(51) Int. Cl. H02J 7/34; H02J 7/00; H02J 7/35; H02J 50/10; H01M 10/44; H01M 10/48

(52) U.S. Cl. CPC H02J 7/345; H02J 7/00032; H02J 7/00308; H02J 7/0042; H02J 7/0048; H02J 7/35; H02J 50/10; H01M 10/44; H01M 10/48; H02J 2207/20; H02M 3/1582

(57) ABSTRACT

A rechargeable battery comprises a casing, a power receiving module, a charge management module, a storage capacitor, a positive electrode, and a negative electrode. The power receiving module is for outputting an input power. The charge management module is disposed in the casing and electrically connected to the power receiving module to receive the input power and convert the input power to a charge power. The storage capacitor, which is a supercapacitor or a lithium-ion capacitor, is disposed in the casing and electrically connected to the charge management module, and the charge power charges the storage capacitor. The positive electrode and the negative electrode are disposed at the casing and partly exposed outside the casing. The positive electrode and the negative electrode are electrically connected to the storage capacitor to supply an output power.

### BACKGROUND OF THE INVENTION

### Technical Field

The present invention generally relates to a battery, and more particularly to a rechargeable battery.

### Description of Related Art

Dry batteries sold in the market cannot be reused after running out of electricity. They need to be recycled, which leads to an environmental impact. On the other hand, rechargeable batteries can be recharged many times and have a lower environmental impact than dry batteries. Rechargeable batteries are common in nickel-metal hydride batteries and lithium-ion batteries. Nickel-metal hydride batteries are cheaper but have a memory effect and a longer charging time. Lithium-ion batteries are more expensive but have no memory effect and the charging time is shorter than nickel-metal hydride batteries; however, lithium-ion batteries are prone to risks of burning due to collision.

When charging a conventional rechargeable battery, a dedicated charger is needed. The charging power is input to the positive electrode and the negative electrode of the rechargeable battery to reduce chemical substances inside the rechargeable battery. Though, the rechargeable battery requires a long charging time, usually taking several hours to reach a full charge, which contributes to inconvenience in use.

### BRIEF SUMMARY OF THE INVENTION

In view of the above, the object of the present invention is to provide a rechargeable battery which can be easily charged.

In view of the above, the object of the present invention is to provide a rechargeable battery which can be fast charged.

The present invention provides a rechargeable battery, comprising a casing, a power receiving module, a charge management module, a storage capacitor, a positive electrode, and a negative electrode. The power receiving module is for outputting an input power. The charge management module is disposed in the casing and electrically connected to the power receiving module to receive the input power and convert the input power to a charge power. The storage capacitor, which is a supercapacitor or a lithium-ion capacitor, is disposed in the casing and electrically connected to the charge management module, and the charge power charges the storage capacitor. The positive electrode and the negative electrode are disposed at the casing and partly exposed outside the casing. The positive electrode and the negative electrode are electrically connected to the storage capacitor to supply an output power.

The advantage of the present invention is that with the power receiving module and the charge management module, the rechargeable battery could be easily charged without a traditional rechargeable battery charger. In addition, with the property of fast charging, the storage capacitor could be full charged in such a short period of time that the rechargeable battery could be used again shortly.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of a rechargeable battery of a first preferred embodiment according to the present invention;

FIG. 2 is a schematic view showing an internal structure of the rechargeable battery of the first preferred embodiment;

FIG. 3 is a circuit block diagram of the rechargeable battery of the first preferred embodiment;

FIG. 4 is a circuit diagram of the rechargeable battery of the first preferred embodiment;

FIG. 5 is a circuit diagram of a rechargeable battery of a second preferred embodiment;

FIG. 6 is a circuit diagram of a rechargeable battery of a third preferred embodiment;

FIG. 7 is a schematic view of a rechargeable battery of a fourth preferred embodiment;

FIG. 8 is a schematic view of a rechargeable battery of a fifth preferred embodiment;

FIG. 9 is a circuit block diagram of the rechargeable battery of the fifth preferred embodiment;

FIG. 10 is a schematic view showing charging an electronic device with the rechargeable battery of the fifth preferred embodiment;

FIG. 11 is a schematic view showing charging the electronic device with the rechargeable battery of the fifth preferred embodiment;

FIG. 12 is a circuit block diagram of a rechargeable battery of a sixth preferred embodiment;

FIG. 13 is a schematic view of an electronic device with a rechargeable battery of a seventh preferred embodiment;

FIG. 14 is a schematic view of a rechargeable battery of an eighth preferred embodiment;

FIG. 15 is a perspective view of a rechargeable battery of a ninth preferred embodiment;

FIG. 16 is an exploded perspective view of the rechargeable battery of the ninth preferred embodiment;

FIG. 17 is a front view of a casing of the rechargeable battery of the ninth preferred embodiment.

FIG. 18 is a schematic view of an operation mode of the rechargeable battery of a tenth preferred embodiment;

FIG. 19 is a circuit block diagram of the rechargeable battery of the tenth preferred embodiment; and

FIG. 20 is a circuit block diagram of the rechargeable battery of an eleventh embodiment.

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification.

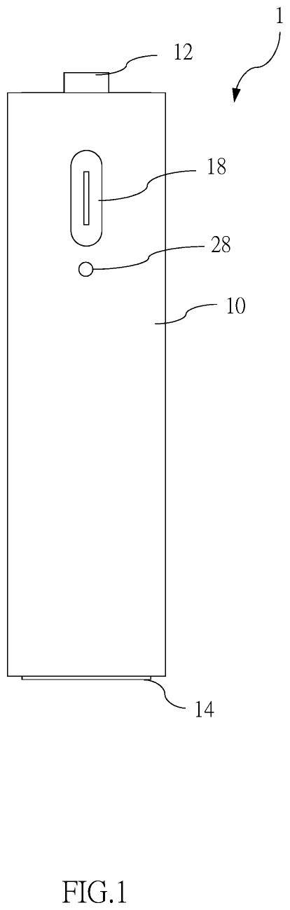

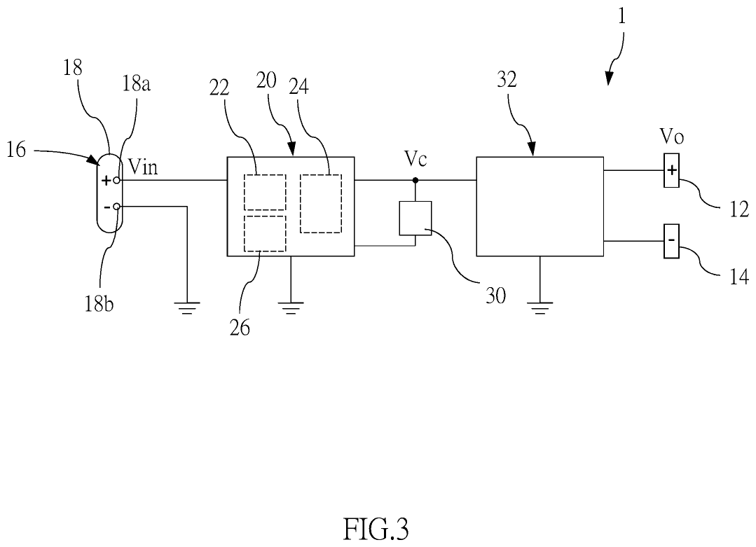

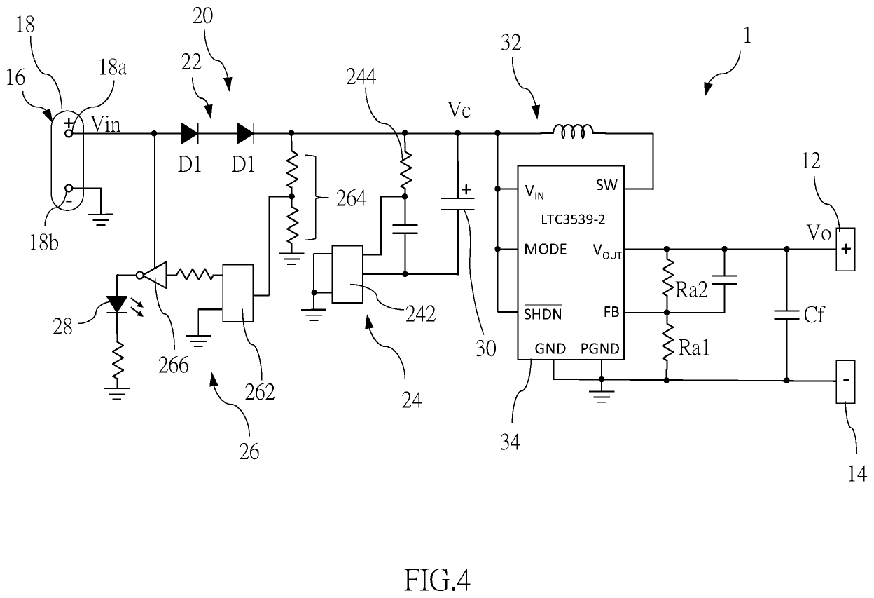

A rechargeable battery 1 of a first preferred embodiment according to the present invention is illustrated in FIG. 1 to FIG. 4. At least the dimension of the rechargeable battery 1 complies with a specification of the dry battery of International Electrotechnical Commission (IEC), such as LR20, LR14, 6LR61, 6F22, 4LR61, LR6, LR03, LR1, LR8D425, 4R25Y, 4LR25X, or 4LR25-2, or complies with a specification of the lithium-ion battery, such as cylindrical lithium-ion battery 26650, 21700, 18650, 17670, 18500, 18350, 17500, 16340, 14500, or 10440, as well as 3V CR2032, CR2025, and 12V 23 A batteries. Preferably, a voltage and/or capacity could also comply with the above specifications. It must be pointed out that the specifications described above are only examples but not intended to limit the present invention. In the current embodiment, the dimension of the rechargeable battery 1 is LR6 as an example, namely AA battery or UM 3 (JIS).

The rechargeable battery 1 comprises a casing 10, a positive electrode 12, a negative electrode 14, a power receiving module 16, a charge management module 20, and a storage capacitor 30.

The casing 10 is formed by two connecting sub-casings with an accommodating space 10a inside to house the power receiving module 16, the charge management module 20, and the storage capacitor 30. The sub-casings can be made of plastic material and ultrasonically welded to form the casing 10.

The positive electrode 12 is disposed at the casing 10 and partly exposed outside the casing 10. The negative electrode 14 is disposed at the casing 10 and partly exposed outside the casing 10.

The power receiving module 16 is disposed in the casing 10 for receiving an external power and outputting an input power Vin.

In the current embodiment, the power receiving module 16 includes a connector 18 which is a female connector, such as mini USB, micro USB, USB type-C, or Lightning. The connector 18 has at least one positive contact 18a and at least one negative contact 18b, and is for joining a male connector to receive the external power. Voltages of the external power can be 4.8V to 5.2V.

The charge management module 20 is disposed in the casing 10 and is electrically connected to the power receiving module 16. The charge management module 20 receives the input power Vin and converts the input power Vin to a charge power Vc. In the current embodiment, the charge management module 20 includes a buck circuit 22 to step down a voltage of the input power Vin to form the charge power Vc. The buck circuit 22 includes at least one diode D1. Two diodes D1 in series connection are used in the current embodiment, and a forward bias voltage of each diode D1 is 0.5V. The buck circuit 22 is electrically connected to the connector 18. After being stepped down by the two diodes D1, the input power Vin forms the charge power Vc. The power receiving module 16 receives the external power to output the input power Vin. When a voltage of the input power Vin is greater than a voltage of the storage capacitor 30, the two diodes D1 are in forward conduction, and the charge power Vc can charge the storage capacitor 30.

The storage capacitor 30 is disposed in the casing 10 and is electrically connected to the charge management module 20. The charge power Vc charges the storage capacitor.

In the current embodiment, the storage capacitor 30 is a supercapacitor or a lithium-ion capacitor. The storage capacitor 30 has a capacitance of 40 F or more and has a working voltage of 3.8V, but it is not limited thereto. Based on different sizes of the accommodating space 10a, the capacitance can be 200 F and above, or 250 F and above.

Since the storage capacitor 30 is the supercapacitor or the lithium-ion capacitor, it has the advantages of stable performance, short charging time, long cycle life, high power density, and good high/low temperature performance. The storage capacitor 30 has safety features. There is no oxidation-reduction chemical reaction during charging, and there is no risk of burning like a traditional lithium-ion battery, either. The storage capacitor 30 is also environmentally friendly, without traditional heavy metal materials, such as cadmium, lead, and mercury. The storage capacitor 30 offers over one hundred thousand charge-discharge cycles, light weight, no battery memory effect, and stable voltage. The storage capacitor 30 will not be subject to battery leakage, and the lithium-ion capacitor further offers a characteristic of high instantaneous output current.

To prevent the storage capacitor 30 from over charging and/or over discharging, the charge management module 20 further includes a protection circuit 24 electrically connected to the storage capacitor 30 in the current embodiment. The protection circuit 24 detects a voltage of the charge power Vc. When the detected voltage of the charge power Vc is greater than a predetermined charge voltage, the protection circuit 24 cuts off the charge power supplied to the storage capacitor 30. In the current embodiment, the protection circuit 24 is provided with a protection circuit component 242, which may use the model XB5532, AP9211, DW3, or an equivalent IC. The protection circuit 242 is electrically connected to a positive terminal of the storage capacitor 30 via a resistor 244 and is directly electrically connected to a negative terminal of the storage capacitor 30. Normally, the negative terminal of the storage capacitor 30 is electrically connected to the ground via the protection component 242. When the voltage of the charge power Vc is greater than the predetermined charge voltage, the protection component 242 cuts off the electrical connection between the negative terminal of the storage capacitor 30 and the ground to cut off the charge power Vc supplied to the storage capacitor 30.

When the connector 18 is not connected to the external power, there is no charge power Vc to be supplied to the storage capacitor 30. Under the circumstances, the protection circuit 24 detects the voltage of the storage capacitor 30, and when the detected voltage of the storage capacitor 30 is less than a predetermined discharge voltage, the protection circuit 24 cuts off a discharge path of the storage capacitor 30. In the current embodiment, it is the protection component 242 to cut off the electrical connection between the negative terminal of the storage capacitor 30 and the ground to cut off the discharge path.

The charge management module 20 further includes a charge indicator circuit 26 and a light emitting component 28 which is an LED. When the charge indicator circuit 26 detects that the voltage of the charge power Vc supplied to the storage capacitor 30 is less than a predetermined voltage, the charge indicator circuit 26 controls the light emitting component 28 to emit light. When the charge indicator circuit 26 detects that the voltage of the charge power Vc supplied to the storage capacitor 30 reaches the predetermined voltage, the charge indicator circuit 26 controls the light emitting component 28 to stop emitting light.

In the current embodiment, the charge indicator circuit 26 includes a voltage detection component 262, a voltage divider circuit 264, and an inverter component 266. A detection terminal of the voltage detection component 262 is electrically connected to the positive terminal of the storage capacitor 30 via the voltage divider circuit 264. The voltage detection component 262 detects the voltage of the charge power Vc supplied to the storage capacitor 30 via the voltage divider circuit 264. An output terminal of the voltage detection component 262 is electrically connected to an input terminal of the inverter component 266, an output terminal of the inverter component 266 is electrically connected to the light emitting component 28, and a control terminal of the inverter component 266 is electrically connected to the positive contact 18a of the connector 18. When the connector 18 outputs the input power Vin, the inverter component 266 is enabled. When the voltage detection component 262 detects that the voltage of the charge power Vc supplied to the storage capacitor 30 is less than the predetermined voltage, the voltage detection component 262 outputs a low level signal, and the inverter component 266 converts the low level signal output by the voltage detection component 262 to a high level signal to control the light emitting component 28 to emit light. When the voltage detection component 262 detects that the voltage of the charge power Vc supplied to the storage capacitor 30 reaches the predetermined voltage, the voltage detection component 262 outputs a high level signal. The inverter component 266 converts the high level signal output by the voltage detection component 262 to a low level signal to control the light emitting component 28 to stop emitting light. The voltage detection component 262 may use ME2807, XC62FN3812MR, or an equivalent IC while the inverter component 266 may use DTA144VUA or an equivalent IC.

In the current embodiment, the rechargeable battery 1 further includes a power conversion module 32 electrically connected between the storage capacitor 30, and the positive electrode 12 and the negative electrode 14. The power conversion module 32 is for converting the power of the storage capacitor 30 to the output power Vo. The power conversion module 32 includes a buck-boost component 34 for regulating the voltage of the output power. The buck-boost component 34 may use LTC3539-2, MP1601, or an equivalent IC and can be selectively electrically connected to a first adjustment resistor Ra1 and a second adjustment resistor Ra2.

An input terminal of the buck-boost component 34 receives voltages ranging from 2.5V to 4.2V and outputs a corresponding voltage of the output power Vo in correspondence to the ratio of the first adjustment resistor Ra1 to the second adjustment resistor Ra2. The voltage of the output power Vo is 1.2V×(1+Ra1/Ra2). In the current embodiment, Ra1=137KΩ, Ra2=549KΩ, the voltage of the output power Vo is 1.5V, namely 1.2×(1+137K/549K), but it is not limited thereto. When Ra1=825KΩ, the voltage of the output power Vo is 3V, namely 1.2×(1+825K/549K). The voltage of the output power Vo can also be adjusted to 1.2V to 5.25V.

An output terminal of the buck-boost component 34 is electrically connected to the positive electrode 12 while a ground terminal of the buck-boost component 34 is electrically connected to the negative electrode 14 and the negative contact 18b. In other words, the positive electrode 12 and the negative electrode 14 are electrically connected to the storage capacitor 30 via the power conversion module 32, and the output power Vo is output by the positive electrode 12 and the negative electrode 14. A filter capacitor Cf is selectively connected to the positive electrode 12 and the negative electrode 14.

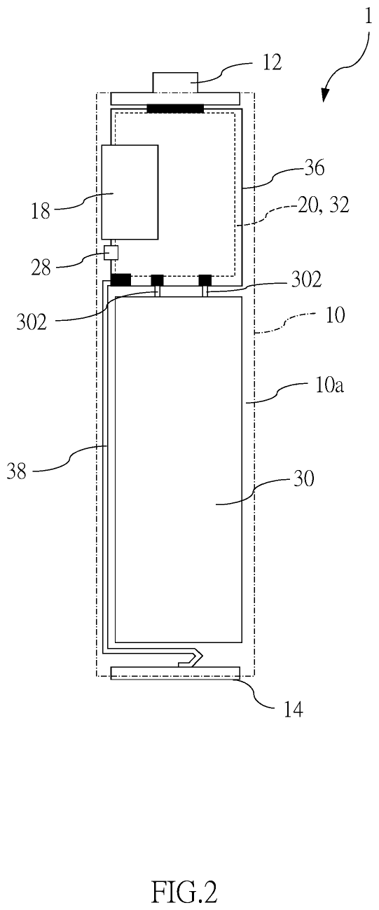

The charge management module 20 and the power conversion module 32 are disposed at a circuit board 36. As shown in FIG. 2, the positive electrode 12 and the negative electrode 14 are spaced apart in an axial direction of the casing 10. The circuit board 36 and the storage capacitor 30 are arranged in the axial direction between the positive electrode 12 and the negative electrode 14. The storage capacitor 30 is disposed at a side of the circuit board 36 between the circuit board 36 and the negative electrode 14. The storage capacitor 30 has two pins 302 (namely the positive terminal and the negative terminal) connected to the circuit board 36 and electrically connected to the charge management module 20. At least one of the positive electrode 12 and the negative electrode 14 is connected to the circuit board 36 via at least one conductive member 38 to be electrically connected to the storage capacitor 30. The negative electrode 14 is connected to the circuit board 36 via the conductive member 38 which is a metal spring plate in the current embodiment and can be electrically connected to the storage capacitor 30 via the power conversion module 32. The two pins 302, the conductive member 38, and the positive electrode 12 are soldered to the circuit board 36. In another embodiment, the negative electrode 14 may be a metal cylinder and extends around the circuit board 36. Meanwhile, the conductive member 38 may be a Pogo Pin to connect the negative electrode 14 and the circuit board 36.

With the above-mentioned architecture, the power receiving module 16 receives the external power to output the input power Vin. When the voltage of the input power Vin is greater than the voltage of the storage capacitor 30, the two diodes D1 are in forward conduction to charge the storage capacitor 30. With the property of fast charging, the charging time of the storage capacitor 30 is less than 4 minutes. Based on different types of storage capacitor 30, the charging time may be less than 3.5 minutes, 1 minute, 15 seconds, or even less than 10 seconds; the less the capacitance, the shorter the charging time. In this way, the storage capacitor 30 could be fully charged in a short period of time, which would greatly reduce the charging time compared with a conventional rechargeable battery.

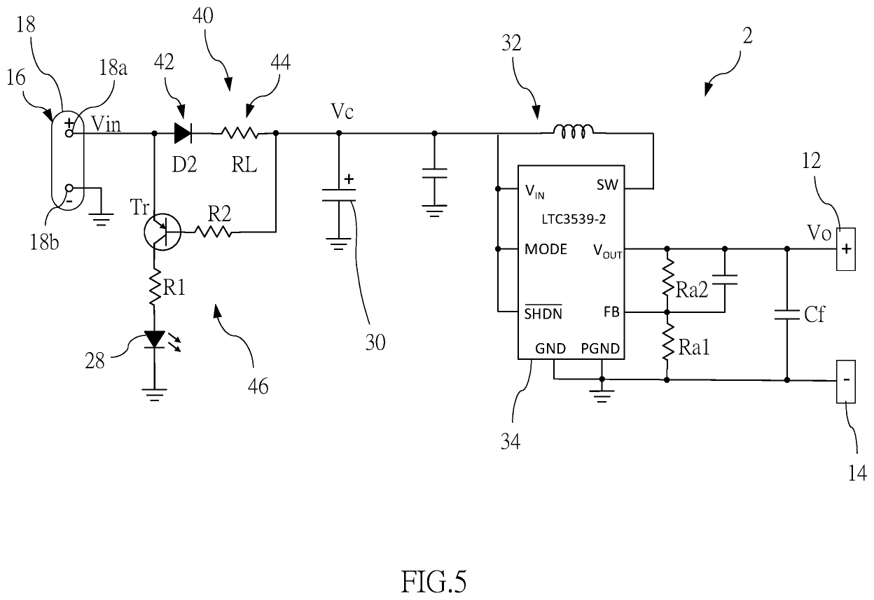

A circuit block diagram of a rechargeable battery 2 of a second preferred embodiment according to the present invention is shown in FIG. 5, wherein the rechargeable battery 2 includes a structure which is similar to the rechargeable battery 1 of the first embodiment, except that a buck circuit 42 of a charge management module 40 includes a diode D2, and a forward bias voltage of the diode D2 is 1.1V.

A protection circuit 44 of the current embodiment includes a current limiting resistor RL. One end of the current limiting resistor RL is electrically connected to a cathode of the diode D2 while the other end of the current limiting resistor RL is electrically connected to a positive terminal of the storage capacitor 30. Since the current limiting resistor RL has extremely small resistance (taking 1Ω as an example), a voltage drop of the current limiting resistor RL is very small and a voltage of the cathode of the diode D2 can be regarded as a voltage of the charge power Vc. In practice, the current limiting resistor RL may not be provided and the cathode of the diode D2 can be directly electrically connected to the positive electrode 12 of the storage capacitor 30 so that the power of the cathode of the diode D2 will be the charge power Vc. The negative terminal of the storage capacitor 30 is electrically connected to the negative contact 18b. In another embodiment, an active current limiting component such as XC6209, XC6230, or an equivalent IC can be used.

In the current embodiment, the charge indicator circuit 46 includes a switch component which is a transistor Tr as an example, a first resistor R1, and a second resistor R2. The transistor Tr has a first terminal, a second terminal, and a third terminal, in which the first terminal is electrically connected to the positive contact 18a, the second terminal is electrically connected to the first resistor R1, and the third terminal is electrically connected to the second resistor R2. In the current embodiment, the transistor Tr is a BJT, which is a PNP BJT as an example, but it is not limited thereto, it may also be an FET. The first resistor R1 is electrically connected to one end of the light emitting component 28, and the other end of the light emitting component 28 is electrically connected to the negative contact 18b. One end of the second resistor R2 is electrically connected to the positive terminal of the storage capacitor 30.

With the above-mentioned architecture, the power receiving module 16 receives the external power to output the input power Vin. When the voltage of the input power Vin is greater than the voltage of the storage capacitor 30, the diode D2 is in forward conduction to charge the storage capacitor 30. A voltage of the third terminal of the transistor Tr facilitates conduction between the first terminal and the second terminal to make the light emitting component 28 emit light.

When the power receiving module 16 does not receive the external power or when the voltage of the input power Vin is less than the voltage of the storage capacitor 30, the transistor Tr is cut off between the first terminal and the second terminal so the light emitting component 28 does not emit light.

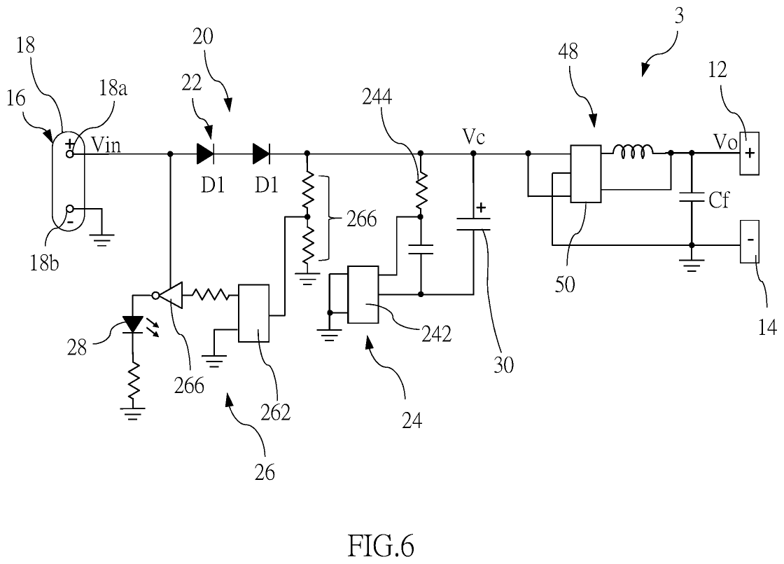

A circuit block diagram of a rechargeable battery 3 of a third preferred embodiment according to the present invention is shown in FIG. 6, wherein the rechargeable battery 3 includes a structure which is similar to the rechargeable battery 1 of the first embodiment, except that a power conversion module 48 includes a buck component 50. The buck component 50 steps down the voltage of the power of the storage capacitor 30 to form the output power Vo. The buck component 50 may use XC9265 or an equivalent IC.

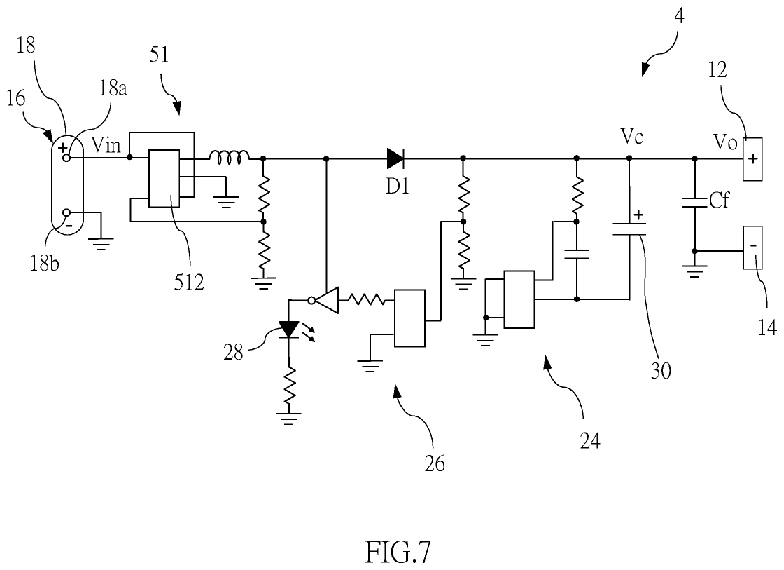

A circuit block diagram of a rechargeable battery 4 of a fourth preferred embodiment according to the present invention is shown in FIG. 7, wherein the rechargeable battery 4 includes a structure which is similar to the rechargeable battery 1 of the first embodiment, except that a buck circuit 51 includes a buck component 512 and a diode D1. The buck component 512 may use RY3420 or an equivalent IC. In addition, the power conversion module 32 is not provided in the current embodiment. The positive terminal of the storage capacitor 30 is directly electrically connected to the positive electrode 12 while the negative terminal of the storage capacitor 30 is electrically connected to the negative electrode 14 via the protection component 24 to be electrically connected to the ground. In this way, the power of the storage capacitor 30 is output directly by the positive electrode 12 and the negative electrode 14 to form the output power Vo. The voltage of the output power Vo is the voltage of the storage capacitor 30. In the current embodiment, the voltage of the storage capacitor 30 ranges from 2.5V to 3.8V.

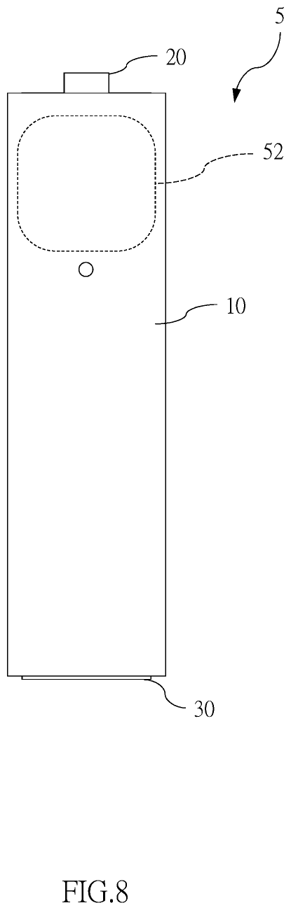

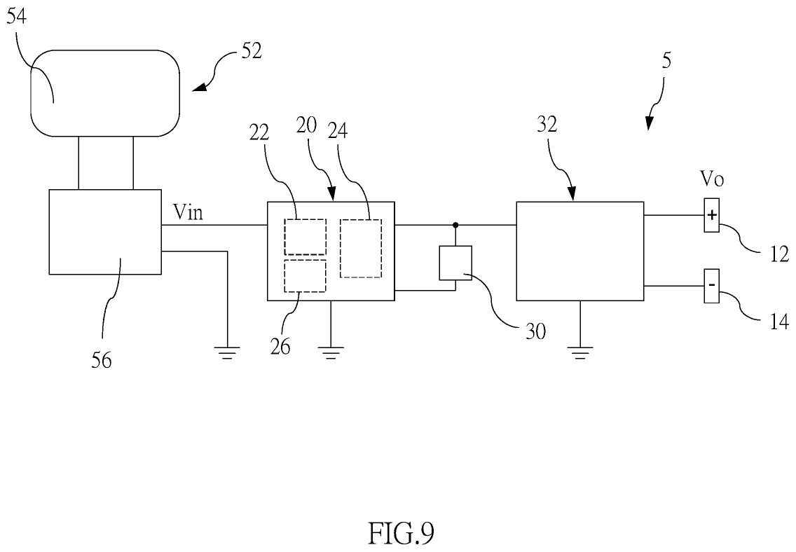

A rechargeable battery 5 of a fifth preferred embodiment according to the present invention is shown in FIG. 8 and FIG. 9, wherein the rechargeable battery 5 includes a structure which is similar to the rechargeable battery 1 of the first embodiment, except that a power receiving module 52 includes a receiving coil 54 and a receiving circuit 56, and the receiving circuit 56 can be electrically connected to the charge management module 20 by, for example, a flat flexible cable. The receiving coil 54 is for receiving an external charge energy while the receiving circuit 56 is electrically connected to the receiving coil 54 and converts the charge energy received by the receiving coil 54 to the input power Vin. In this way, the rechargeable battery 5 can be placed at a wireless charger 200 to receive the charge energy of the wireless charger 200 to charge the storage capacitor 30.

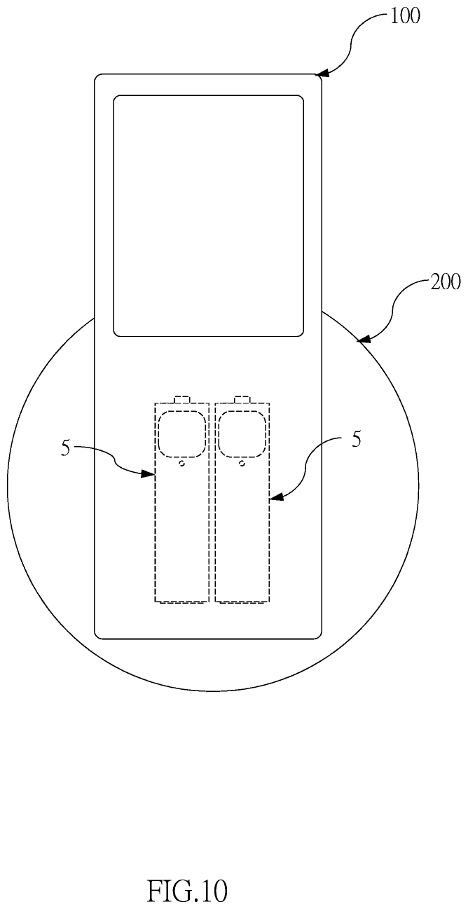

As shown in FIG. 10, when the rechargeable battery 5 is installed in an electronic device which is a remote control 100 as an example, the remote controller 100 can be directly placed at the wireless charger 200 to charge the rechargeable battery 5 without detaching the rechargeable battery 5 from the remote control 100.

The structure of the power receiving module 52 in the current embodiment can also be applied to the second to the fourth embodiments.

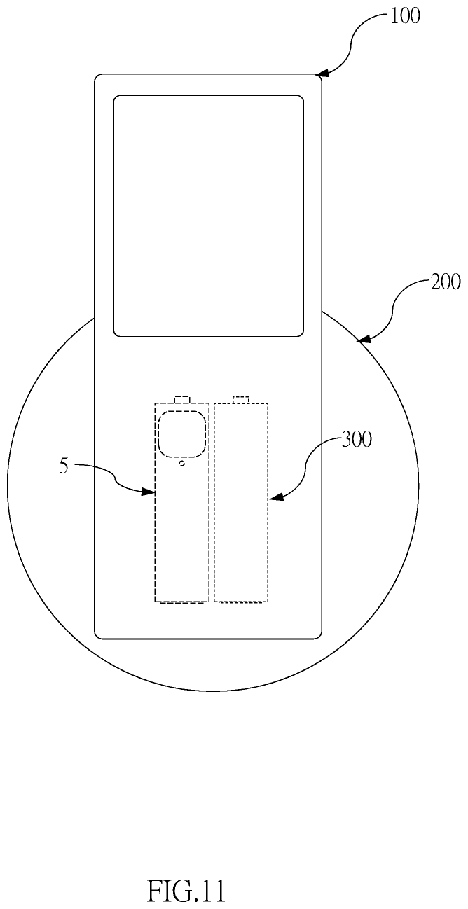

Alternatively, the voltage of the output power Vo of the rechargeable battery 5 is greater as shown in FIG. 11, for example, the voltage of the output power Vo of a single rechargeable battery 5 reaches 2.5V or 3V, and a dummy battery 300 can be installed to fill the empty spot in the remote control. With the direct conduction between a positive electrode and a negative electrode of the dummy battery 300 and the series connection of the dummy battery 300 and the rechargeable battery, namely the power of the rechargeable battery 5 is supplied to the remote control 100, the remote control 100 can be directly placed at the wireless charger 200 to charge the rechargeable battery 5 without detaching the rechargeable battery 5 from the remote control 100.

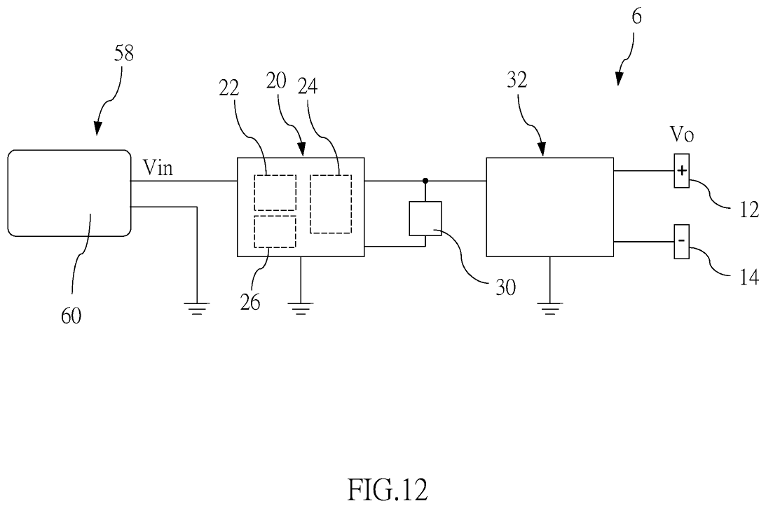

A rechargeable battery 6 of a sixth preferred embodiment according to the present invention is shown in FIG. 12, wherein the rechargeable battery 6 includes a structure which is similar to the rechargeable battery 1 of the first embodiment, except that a power receiving module 58 includes a receiving antenna 60 disposed at the casing 10. The receiving antenna 60 receives a wireless signal and converts the energy of the wireless signal, such as Wi-Fi, Bluetooth, or cellular network, to the input power Vin to charge the rechargeable battery 6 without a charger.

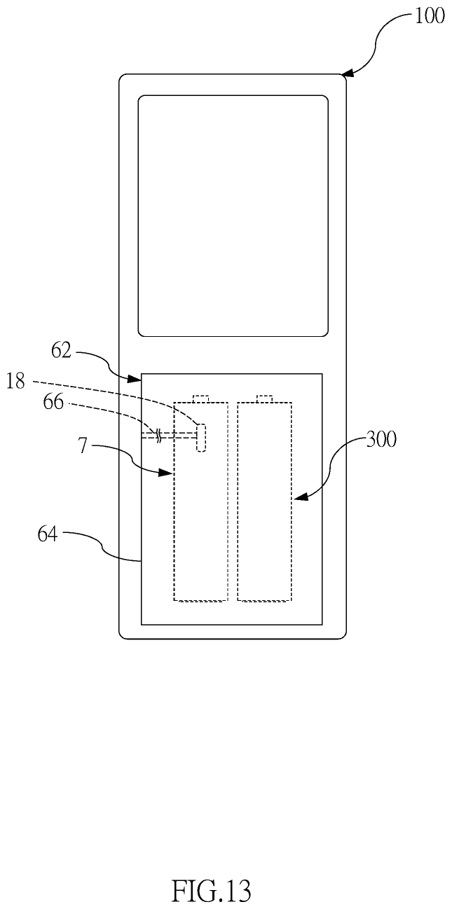

A rechargeable battery 7 of a seventh preferred embodiment according to the present invention is shown in FIG. 13, wherein the rechargeable battery 7 includes a structure which is similar to the rechargeable battery 1 of the first embodiment, except that a power receiving module 62 includes a solar panel 64 disposed outside the remote control 100 and electrically connecting the charge management module 20 via a cable 66 connected to the connector 18. The solar panel 64 receives light energy from the outside to charge the storage capacitor 30. Alternatively, rather than using the solar panel 64, the receiving coil 54 and the receiving circuit 56 of the fifth embodiment could be used to be electrically connected to the charge manage module 20 via the cable 66 connecting the connector 18. The receiving coil 54 and the receiving circuit 56 can be integrated into a receiving sheet and the receiving board is disposed outside or inside the remote control 100 to receive the charge energy of the wireless charger 200.

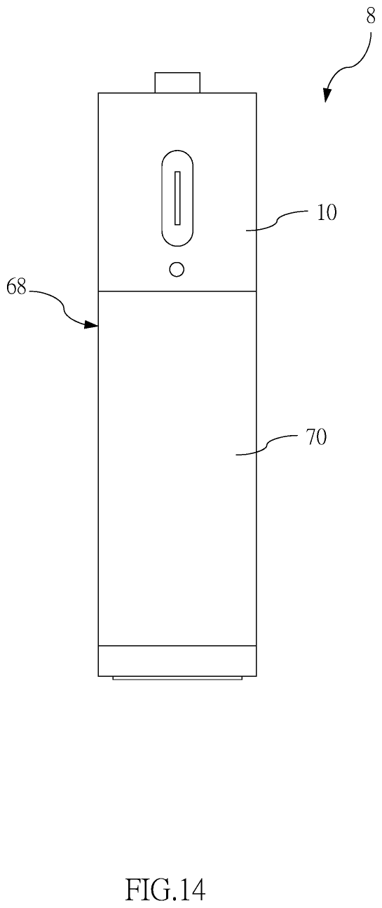

A rechargeable battery 8 of an eighth preferred embodiment according to the present invention is shown in FIG. 14, wherein the rechargeable battery 8 includes a structure which is similar to the rechargeable battery 1 of the first embodiment, except that a power receiving module 68 includes a solar panel 70 disposed at the casing 10 and electrically connected to the charge management module 20. An outer surface of the solar panel 70 does not substantially protrude from the outer peripheral surface of the casing 10. Preferably, the outer surface of the solar panel 70 is flush with the outer peripheral surface of the casing 70. Thereby, the rechargeable battery 8 could be charged after exposure to the light.

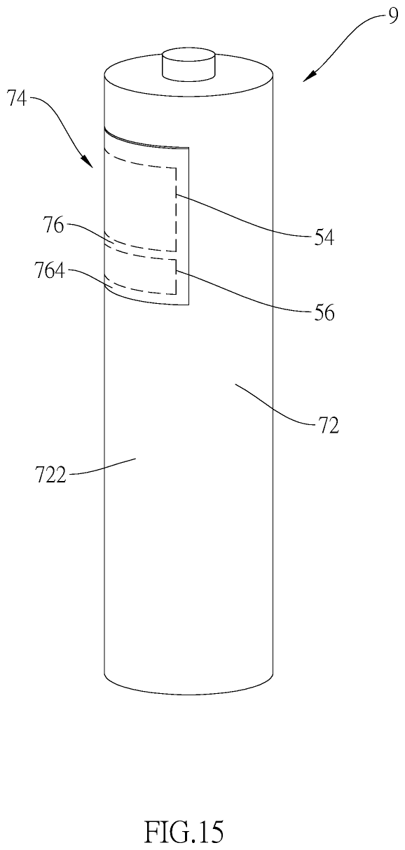

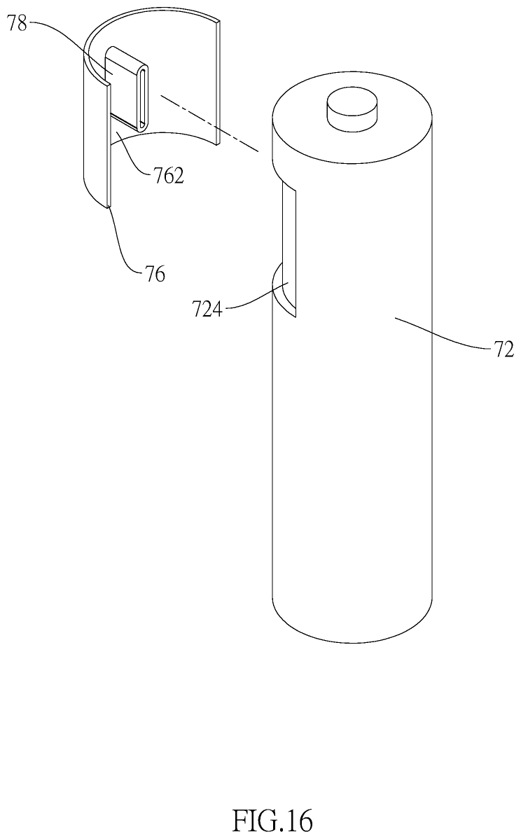

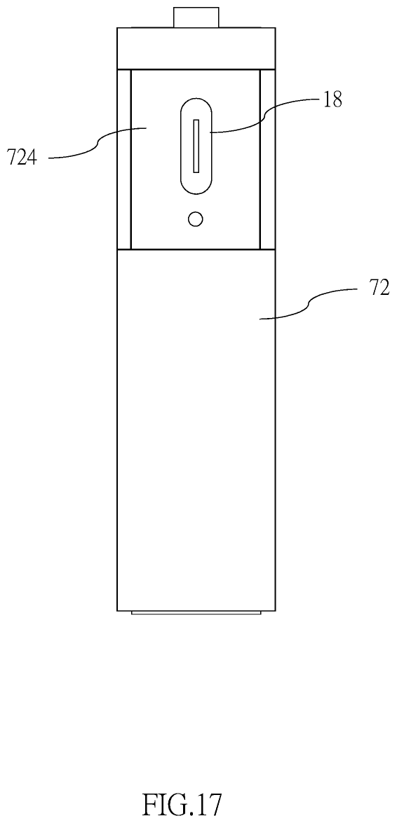

A rechargeable battery 9 of a ninth preferred embodiment according to the present invention is shown in FIG. 15 to FIG. 17, wherein the rechargeable battery 9 includes a structure which is similar to the rechargeable battery 5 of the fifth embodiment, except that an outer peripheral surface 722 of the casing 72 recessed to form a recess 724 and the connector 18 is located inside the recess 724. The power receiving module 74 includes the connector 18, a cover 76, and a male connector 78, in which the connector 18 is disposed in the recess 724 and is electrically connected to the charge management module 20. The cover 76 is provided with the receiving coil 54 and the receiving circuit 56 and has an arc shape which matches the recess 724. The male connector 78 is disposed at an inner surface 762 of the cover 76 and is electrically connected to the receiving circuit 56. The cover 76 is detachably engaged in the recess 724 at the casing 72 and the male connector 78 is detachably joined to the connector 18. An outer surface 764 of the cover 76 does not substantially protrude from the outer peripheral surface 722 of the casing 72. Preferably, the outer surface 764 of the cover 76 is flush with the outer peripheral surface 722 of the casing 72.

In this way, the rechargeable battery 9 can be charged when placed at the wireless charger 200. When not using the function of wireless charging, the cover 76 could be detached to plug another male connector with power (not shown) in the connector 18.

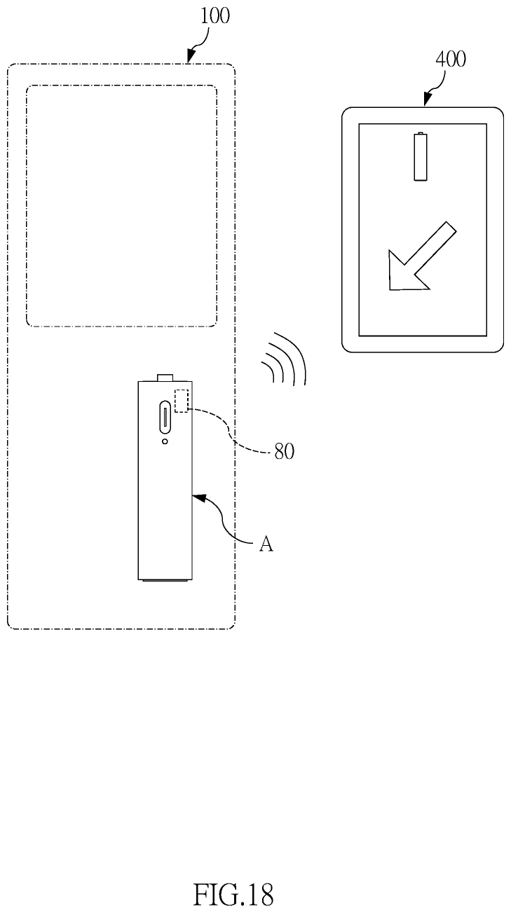

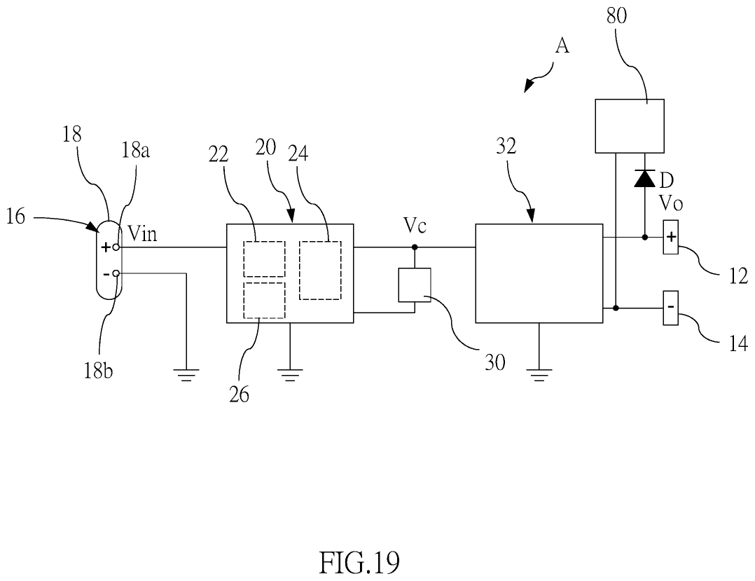

A rechargeable battery A of a tenth preferred embodiment according to the present invention is shown in FIG. 18 and FIG. 19, wherein the rechargeable battery A includes a structure which is similar to the rechargeable battery 1 of the first embodiment and further includes a wireless signal transceiver 80 disposed inside the casing 10. The wireless signal transceiver 80 is electrically connected to the positive electrode 12 and the negative electrode 14 to receive the output power Vo to operate. In the current embodiment, the wireless signal transceiver 80 is electrically connected to the positive electrode 12 via a diode D. The rechargeable battery A is installed in an electronic device such as the remote control 100.

The wireless signal transceiver 80 can be, for example, a smart tag, and the wireless signal transceiver 80 is for transmitting a wireless signal carrying an identification code. The wireless signal transceiver 80 can communicate with a mobile device 400, and the mobile device 400 records the identification code and corresponds to an electronic device or a rechargeable battery of the identification code. The wireless signal can be, for example, a Bluetooth signal. When the wireless signal transceiver 80 continues to transmit the wireless signal, the mobile device 400 receives the wireless signal, determines whether the electronic device or the rechargeable battery corresponding to the received wireless signal transceiver 80 according to the identification code is the desired one, and determines a position of the wireless signal transceiver 80 relative to the mobile device 400 by the wireless signal. In this way, a user can easily find out where the rechargeable battery A or the electronic device installed with the rechargeable A is placed. In another embodiment, the wireless signal transceiver 80 is provided with a buzzer and the mobile device 400 can transmit a command to the wireless signal transceiver 80 to make the buzzer sound. In another embodiment, the wireless signal transceiver 80 is provided with a power detection device. The mobile device 400 can obtain the battery power and display it on a display of the mobile device 400.

The wireless signal transceiver 80 in the current embodiment can be applied to the rechargeable batteries of the second to the ninth embodiments.

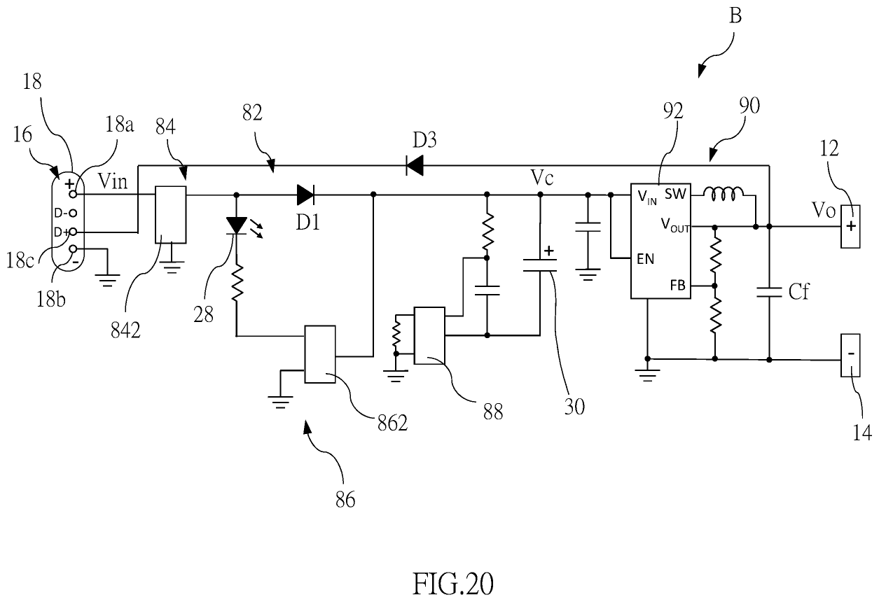

A circuit block diagram of a rechargeable battery B of an eleventh preferred embodiment according to the present invention is shown in FIG. 20, wherein the circuit block includes a structure which is similar to the circuit block of the first embodiment, except that a buck circuit 84 of a charge management module 82 includes a buck component 842 and a diode D1. The buck component 842 may use XC6230, XC6209, or an equivalent IC. The buck component 842 can achieve the purpose of active current limiting.

In addition, the charge management module 82 further includes a charge indicator circuit 86 and a light emitting component 28. The charge indicator circuit 86 includes a voltage detection component 862 which may use XC61FN3812MR or an equivalent IC. A detection terminal of the voltage detection component 862 is electrically connected to the positive terminal of the storage capacitor 30. The light emitting component 28 is electrically connected between an output terminal of the buck component 842 and an output terminal of the voltage detection component 862, that is, an anode of the light emitting component 28 is electrically connected to the output terminal of the buck component 842 while a cathode of the light emitting component 28 is electrically connected to the output terminal of the voltage detection component 862. When the voltage detection component 862 detects that the charge power Vc supplied to the storage capacitor 30 is less than the predetermined voltage, the voltage detection component 862 outputs a first level signal, which is a low level signal as an example, to control the light emitting component 28 to emit light. When the voltage detection component 862 detects that the charge power Vc supplied to the storage capacitor 30 reaches the predetermined voltage, the voltage detection component 862 outputs a second level signal, which is a high level signal as an example, to control the light emitting component 28 to stop emitting light.

In the current embodiment, a protection component 88 may use AP9211 or an equivalent IC.

In the current embodiment, the rechargeable battery B further includes a power conversion module 90 similar to that in the first preferred embodiment. The power conversion module 90 converts power of the storage capacitor 30 to the output power Vo. A buck-boost component 92 of the power conversion module 90 may use MP1601 or an equivalent IC.

The positive electrode 12 is further electrically connected to a data terminal 18c of the connector 18 by a diode D3, and the data terminal 18c is USB D+.

To sum up, the rechargeable battery of the present invention can be easily charged without a traditional rechargeable battery charger. The storage capacitor provides the advantage of fast charging, effectively shortening the charging time. The rechargeable battery could be applied to an electronic device which has low power consumption, such as a remote control or a clock. The rechargeable battery could be also applied to an electronic device which requires high voltage instantaneously, such as a photoflash or a mosquito swatter. It must be pointed out that the aforementioned uses are only examples but not intended to limit the present invention.

It must be pointed out that the embodiments described above are only some embodiments of the present invention. All equivalent structures which employ the concepts disclosed in this specification and the appended claims should fall within the scope of the present invention.

What is claimed is:

1. A rechargeable battery, comprising:
a casing;
a power receiving module for outputting an input power;
a charge management module disposed in the casing and electrically connected to the power receiving module to receive the input power and convert the input power to a charge power;
a storage capacitor, which is a supercapacitor or a lithium-ion capacitor, disposed in the casing and electrically connected to the charge management module, and the charge power charging the storage capacitor;
a positive electrode and a negative electrode disposed at the casing and partly exposed outside the casing, in which the positive electrode and the negative electrode are electrically connected to the storage capacitor to supply an output power.

2. The rechargeable battery of claim 1, wherein the charge management module includes a protection circuit electrically connected to the storage capacitor to detect a voltage of the charge power; when the detected voltage of the charge power is greater than a predetermined charge voltage, the protection circuit cuts off the charge power supplied to the storage capacitor.

3. The rechargeable battery of claim 1, wherein the charge management module includes a protection circuit electrically connected to the storage capacitor; the protection circuit detects a voltage of the storage capacitor when the storage capacitor does not receive the charge power, and when the detected voltage of the storage capacitor is less than a predetermined discharge voltage, the protection circuit cuts off a discharge path of the storage capacitor.

4. The rechargeable battery of claim 1, wherein the charge management module includes a charge indicator circuit and a light emitting component; when the charge indicator circuit detects that a voltage of the charge power applied to the storage capacitor is less than a predetermined voltage, the charge indicator circuit controls the light emitting component to emit light; when the charge indicator circuit detects that the voltage of the charge power applied to the storage capacitor reaches the predetermined voltage, the charge indicator circuit controls the light emitting component to stop emitting light.

5. The rechargeable battery of claim 4, wherein the charge indicator circuit includes a voltage detection component, a voltage divider circuit, and an inverter component; the voltage detection component is electrically connected to the storage capacitor via the voltage divider circuit, and is electrically connected to the inverter component; the inverter component is electrically connected to the light emitting component; the voltage detection component detects the voltage of the charge power supplied to the storage capacitor via the voltage divider circuit; when the detected voltage of the charge power supplied to the storage capacitor is less than the predetermined voltage, the voltage detection component outputs a low level signal and the inverter component converts the low level signal output by the voltage detection component to a high level signal to control the light emitting component to emit light; when the voltage detection component detects that the voltage of the charge power supplied to the storage capacitor reaches the predetermined voltage, the voltage detection component outputs a high level signal and the inverter component converts the high level signal output by the voltage detection component to a low level signal to control the light emitting component to stop emitting light.

6. The rechargeable battery of claim 4, wherein the charge indicator circuit includes a voltage detection component; a detection terminal of the voltage detection component is electrically connected to the storage capacitor; an output terminal of the voltage detection component is electrically connected to the light emitting component; when the voltage detection component detects the charge power supplied to the storage capacitor is less than the predetermined voltage, the voltage detection component outputs a first level signal to control the light emitting component to emit light; when the voltage detection component detects that the charge power supplied to the storage capacitor reaches the predetermined voltage, the voltage detection component outputs a second level signal to control the light emitting component to stop emitting light.

7. The rechargeable battery of claim 1, wherein the charge management module includes a buck circuit which is electrically connected to the power receiving module and steps down a voltage of the input power to form the charge power.

8. The rechargeable battery of claim 1, comprising a power conversion module electrically connected between the storage capacitor, and the positive electrode and the negative electrode, wherein the power conversion module converts power of the storage capacitor into the output power.

9. The rechargeable battery of claim 8, wherein the power conversion module includes a buck-boost component for regulating a voltage of the output power.

10. The rechargeable battery of claim 8, wherein the power conversion module includes a buck component for stepping down a voltage of the power of the storage capacitor to form the output power.

11. The rechargeable battery of claim 1, wherein the power of the storage capacitor is output to the positive electrode and the negative electrode to form the output power.

12. The rechargeable battery of claim 1, wherein the power receiving module includes a receiving coil and a receiving circuit, in which the receiving coil is for receiving a charge energy while the receiving circuit is electrically connected to the receiving coil and converts the charge energy received by the receiving coil to the input power.

13. The rechargeable battery of claim 12, wherein an outer peripheral surface of the casing recessed to form a recess; the power receiving module includes a female connector, a cover, and a male connector; the female connector is disposed in the recess and is electrically connected to the charge management module; the cover is provided with the receiving coil and the receiving circuit; the male connector is disposed at the cover and is electrically connected to the receiving circuit; the cover is detachably engaged in the recess; the male connector is detachably joined to the female connector.

14. The rechargeable battery of claim 1, wherein the power receiving module includes a receiving antenna disposed at the casing; the receiving antenna receives a wireless signal and converts energy of the wireless signal to the input power.

15. The rechargeable battery of claim 1, wherein the power receiving module includes a solar panel electrically connected to the charge management module.

16. The rechargeable battery of claim 15, wherein the solar panel is disposed at the casing.

17. The rechargeable battery of claim 15, wherein the solar panel is connected to the charge management module via a cable.

18. The rechargeable battery of claim 1, wherein the charge management module is disposed at a circuit board; one side of the circuit board is provided with the storage capacitor; the storage capacitor has two pins which are connected to the circuit board and are electrically connected to the charge management module.

19. The rechargeable battery of claim 18, wherein the positive electrode and the negative electrode are spaced apart in an axial direction, and the circuit board and the storage capacitor are arranged in the axial direction between the positive electrode and the negative electrode; at least one of the positive electrode and the negative electrode is connected to the circuit board via at least one conductive member.

20. The rechargeable battery of claim 1, comprising a wireless signal transceiver disposed inside the casing and electrically connected to the positive electrode and the negative electrode; the wireless signal transceiver receives the output power and transmits a wireless signal carrying an identification code.
